(19) United States
(12) Patent Application Publication
(10) Pub. No.: US 2013/0013558 A1
(43) Pub. Date: Jan. 10, 2013

(54) SEMANTIC CHECKS FOR SYNCHRONIZATION: IMPOSING ORDINALITY CONSTRAINTS FOR RELATIONSHIPS VIA LEARNED ORDINALITY

(76) Inventor: Andrew T. Belk, Portola Valley, CA (US)

(21) Appl. No.: 13/179,290

(22) Filed: Jul. 8, 2011

(51) Int. Cl. G06F 7/00; G06F 17/00

(52) U.S. Cl. 707/610; 707/674; 707/690; 707/E17.005

(57) ABSTRACT

A method and apparatus for semantic checking for synchronization. In one embodiment, a process is provided to define a relationship model for each data type in a first set of data and may store each relationship model. For each entry in a second set of data to be synchronized with the first set of data, the process determines if the entry violates the relationship model for the data type corresponding to the entry.

### FIELD OF THE INVENTION

The field of invention relates generally to computing systems, and, more specifically, to semantic checks for synchronization.

### BACKGROUND

In distributed synchronization of data, data distributed across a plurality of sources in a distributed system may be synchronized. Each source may run a different version of software for synchronization. If the distributed synchronization merges data across the distributed system rather than matches data, multiple instances of the same data may be present in the synchronized data after synchronization is performed. The synchronized data may be replicated across the plurality of sources, thereby propagating the duplicated data. Therefore, there is “garbage in, garbage everywhere” in the distributed system. Moreover, the duplication of data may potentially cause a large increase in the amount of data stored in the distributed system.

Limitations may be imposed (e.g., by an administrator) on the synchronized data to avoid a large increase in the amount of data stored in the distributed system. For example, a limit may be imposed on a number of phone numbers for each contact in a contact list (e.g., 7) or for a number of events at any given date and time (e.g., 2). However, such limitations simply limit the amount of data that can be distributed during synchronization. Furthermore, with more and more data being stored on distributed networks, it may be harder to clearly define an appropriate limit for data.

### SUMMARY OF THE DESCRIPTION

Mechanisms for semantic checks for synchronization are described herein. The semantic checks may impose ordinality constraints for relationships via learned ordinality. The learned ordinality may be defined by a relationship model. In one embodiment, a process can be provided to define a relationship model for each data type in a first set of data. The relationship model may be based on one or more entries in the first set of data. Each entry in the first set of data may be associated with the data type. For each entry in a second set of data, the process can determine if the entry in the second set of data violates the relationship model for the data type corresponding to the entry. The second set of data may be synchronized with the first set of data.

Systems, methods, and machine readable storage media which perform or implement one or more embodiments are also described.

Other features of the present invention will be apparent from the accompanying drawings and from the detailed description which follows.

### BRIEF DESCRIPTION OF THE DRAWINGS

The present invention is illustrated by way of example and not limited in the figures of the accompanying drawings, in which like references indicate similar elements and in which:

FIG. 1 illustrates an exemplary distributed system architecture including one or more mobile devices, servers, and computer systems connected over a network in which embodiments of the present invention may operate;

FIG. 2 illustrates a block diagram of an exemplary computer system in which embodiments of the present invention may operate;

FIG. 3 illustrates an exemplary memory in accordance with one embodiment of the present invention;

FIG. 4 illustrates a flow diagram of a method of semantic checking for synchronization of a first set of data and a second set of data in accordance with embodiments of the present invention;

FIG. 5 illustrates a flow diagram of a method of defining a relationship model in accordance with embodiments of the present invention;

FIG. 6 illustrates a flow diagram of a method of determining a relationship model violation in accordance with embodiments of the present invention;

FIG. 7A illustrates exemplary contact data in accordance with embodiments of the present invention;

FIG. 7B illustrates exemplary calendar data in accordance with embodiments of the present invention;

FIG. 7C illustrates exemplary bookmark data in accordance with embodiments of the present invention;

FIG. 8 illustrates an exemplary relationship model in accordance with embodiments of the present invention; and

FIG. 9 illustrates an exemplary GUI notification in accordance with embodiments of the present invention.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

A distributed system may include multiple computer systems and/or mobile devices to be synchronized. The synchronization of data across the multiple computer systems and/or mobile devices may merge data across the computer systems and/or mobile devices such that each computer system and mobile device has the same data. The data may include different data types, such as contacts for a user (e.g., in a contact list), calendar events (e.g., in a calendar application), bookmarks (e.g., for a web browser), or any other type of data that is synchronized.

If there is a problem (e.g., bug) in the synchronization of the distributed system, the data to be synchronized may be duplicated during synchronization across the distributed system. For example, given a distributed system with three computer systems, data may be synchronized between a third computer system (e.g., a server) and a second computer system (e.g., personal computer of the user) followed by synchronization between the second computer system and the first computer system (e.g., mobile device of the user). If there is a bug in the synchronization process for the distributed system, the synchronization process may duplicate the data from the third computer system onto the second computer system, rather than merge the data. For example, a calendar event on the second computer system may have had 10 invitees and the third computer system may have a calendar event at the same time (e.g., previously synchronized calendar event or a calendar event created separately by a user of the third computer system). If the data on the second computer system is duplicated by the synchronization process, the result could be a calendar event with 20 invitees (the sum of 10 invitees from the third computer system and 10 invitees from the second computer system). When the second computer is synchronized with the first computer system, the data from the second computer system may be duplicated again if the first computer system has a calendar event at the same time. The resulting synchronized data could be a calendar event with 30 invitees on the first computer system (the sum of 10 invitees from the calendar event on the first computer system and 20 invitees from the calendar event on the second computer system). Even if the first computer system did not have a calendar at the same time, a calendar event would be created on the first computer system based on the synchronization, and would have 20 invitees.

Prior to being synchronized with the second computer system, the first computer system storing a first set of data may define a relationship model, or ordinality, for each data type (e.g., contact, calendar, bookmark, etc.) in the first set of data. The relationship model may be based on each entry in the first set of data that is associated with the data type. Data on the first computer system may be synchronized with the (second set of) data on the second computer system. Prior to synchronizing the first set of data and the second set of data, the first computer system or the second computer system may determine for each entry in the second set of data, if the entry violates the relationship model for the data type corresponding to the entry. By determining if each entry in the second set of data violates the relationship model for the data type corresponding to the entry, the duplication and propagation of duplicated data can be avoided. In the above example, 20 invitees were included in an identical calendar event on the second computer system. If the first computer system had created a relationship model for calendar events, the relationship model for calendar events could have been defined to have a maximum of 10 invitees based on the data initially on the first computer system. Prior to synchronizing the data between the first computer system and the second computer system, the first computer system could determine that the calendar event from the second computer system violates the relationship model for calendar events (with 20 invitees versus the maximum 10 invitees). Therefore, the propagation and/or synchronization of duplicated data could be realized and/or avoided.

In one embodiment, the user may be notified if an entry in the second set of data violates the relationship model. In one embodiment, the relationship model may be updated for the data type based on the second set of data. In this embodiment, by updating the relationship model based on the second set of data, the relationship model may continue to be updated based on data that a user believes is acceptable. In the above example, if the relationship model for calendar events on the first computer system is updated based on the second set of data (from the second computer system), the relationship model for calendar events on the first computer system may have a maximum of 20 invitees. During a later synchronization of the first computer system with the second computer, if a calendar event in the second set of data has 20 invitees, the relationship model for calendar events on the first computer system may no longer be violated.

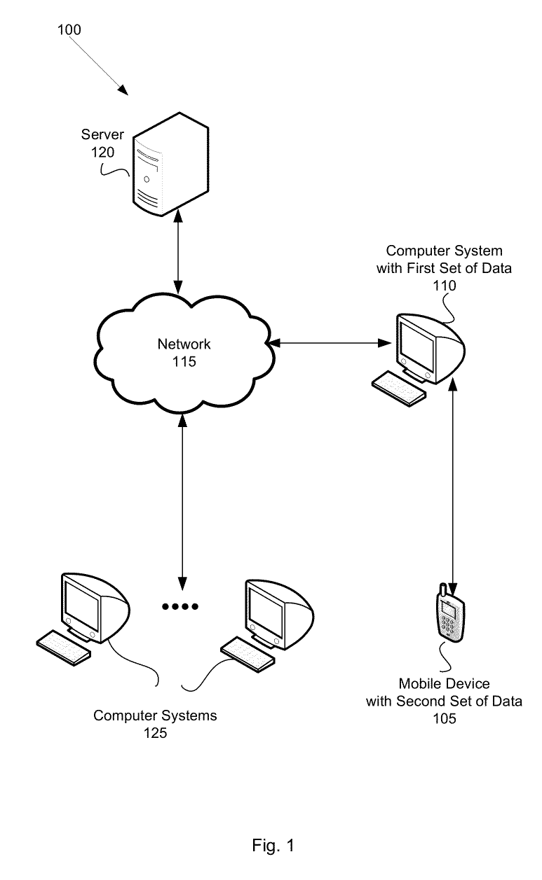

FIG. 1 illustrates a distributed system 100 in which semantic checks for synchronization may be performed. Distributed system 100 may include mobile device with second set of data 105, computer system with first set of data 110, server 120, and computer systems 125. Computer system with first set of data 110 and computer systems 125 may communicate with each other and with server 120 via network 115. In one embodiment, network 115 may be a public network (e.g., Internet) or a private network (e.g., local area network (LAN)).

In one embodiment of the present invention, mobile device with second set of data 105 can communicate with computer system with first set of data 110 in any number of protocols. For example, mobile device with second set of data 105 is connected to computer system with first set of data 110 via a Universal Serial Bus (USB), a IEEE 1394 interface such as FireWire™ available from Apple, Inc. of Cupertino, Calif., or a Small Computer System Interface (SCSI). In yet another embodiment of the present invention, mobile device with second set of data 105 communicates with computer system with first set of data 110 via one or more networks. The networks may include a LAN, WAN, intranet, extranet, wireless network, the Internet, etc. In one embodiment, mobile device with second set of data 105 may be synchronized with computer system with first set of data 110.

In one embodiment, computer system with first set of data 110 can define a relationship model for each data type in the first set of data and may store each relationship model. Upon receiving a synchronization request from mobile device with second set of data 105, computer system with first set of data 110 may determine, for each entry in the second set of data, if the entry violates the relationship model for the data type corresponding to the entry. By determining if each entry in the second set of data violates the relationship model for the data type corresponding to the entry, the duplication and propagation of duplicated data can be determined.

In one embodiment, once computer system with first set of data 110 determines, for each entry in the second set of data, if the entry violates the relationship model for the data type corresponding to the entry, computer system with first set of data 110 and mobile device with second set of data 105 may be synchronized. In one embodiment, synchronization of computer system with first set of data 110 and mobile device with second set of data 105 may merge the first set of data and the second set of data. In an alternate embodiment, synchronization of computer system with first set of data 110 and mobile device with second set of data 105 may match the first set of data and the second set of dat. In one embodiment, once synchronization is performed between computer system with first set of data 110 and mobile device with second set of data 105, the synchronized data may be sent over network 115 to server 120 and/or computer systems 125 and may update the data on server 120 and/or computer systems 125.

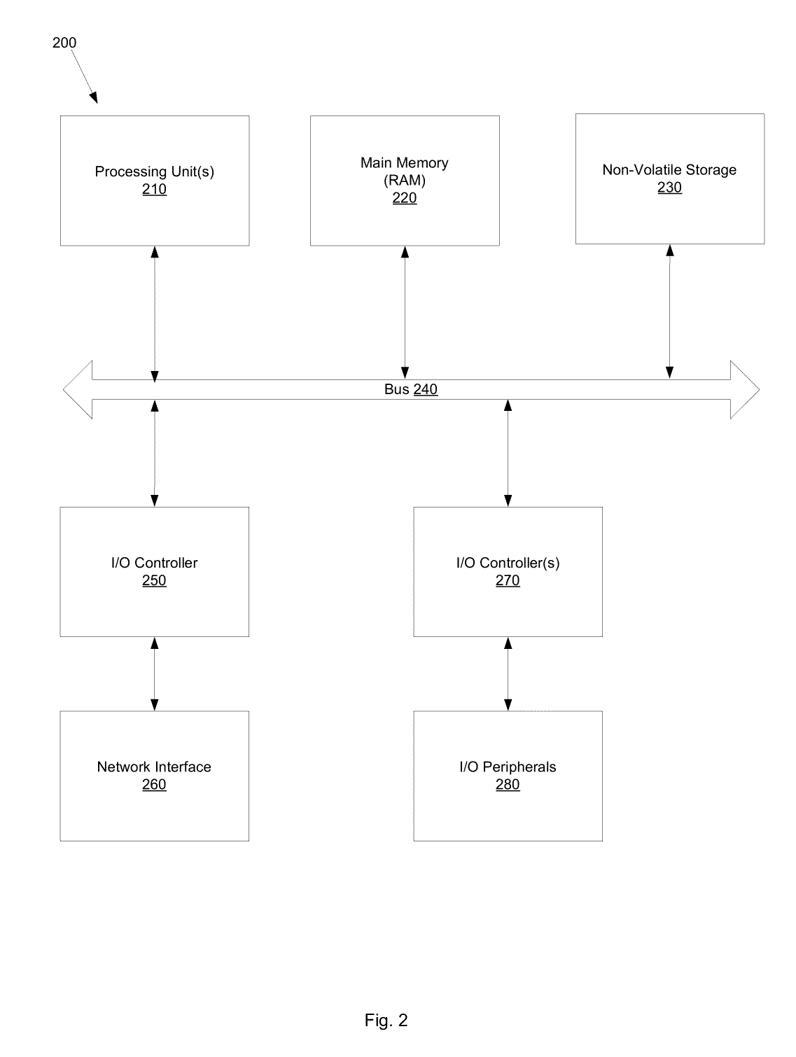

FIG. 2 is a block diagram of an exemplary computer system in which embodiments of the present invention may operate. Computer system 200 includes processing unit(s) 210, main memory (RAM) 220, non-volatile storage 230, bus 240, I/O controller 250, network interface 260, I/O controller 270, and I/O peripherals 280.

Main memory 220 encompasses all volatile or non-volatile storage media, such as dynamic random access memory (DRAM), static RAM (SRAM), or flash memory. Main memory 220 includes storage locations that are addressable by the processing unit(s) 210 for storing computer program code and data structures for semantic checks for synchronization. Such computer program code and data structures also may be stored in non-volatile storage 230. Non-volatile storage 230 includes all non-volatile storage media, such as any type of disk including floppy disks, optical disks such as CDs, DVDs and BDs (Blu-ray Disks), and magnetic-optical disks, magnetic or optical cards, or any type of media, and may be loaded onto the main memory 220. Those skilled in the art will immediately recognize that the term “computer-readable storage medium” or “machine readable storage medium” includes any type of volatile or non-volatile storage device that is accessible by a processor (including main memory 220 and non-volatile storage 230).

Processing unit(s) 210 is coupled to main memory 220 and non-volatile storage 230 through bus 240. Processing unit(s) 210 includes processing elements and/or logic circuitry configured to execute the computer program code and manipulate the data structures. It will be apparent to those skilled in the art that other processing and memory means, including various computer readable storage media, may be used for storing and executing computer program code pertaining to semantic checks for synchronization.

Processing unit(s) 210 can retrieve instructions from main memory 220 and non-volatile storage 230 via bus 240 and execute the instructions to perform operations described below. Bus 240 is coupled to I/O controller 250. I/O controller 250 is also coupled to network interface 260. Network interface 260 can connect to a network to download data to be synchronized from a computer system connected to the network and to send synchronized data to a computer system connected to the network.

Bus 240 is further coupled to I/O controller(s) 270. I/O controller(s) 270 are coupled to I/O peripherals 280, which may be mice, keyboards, modems, disk drives, printers and other devices which are well known in the art.

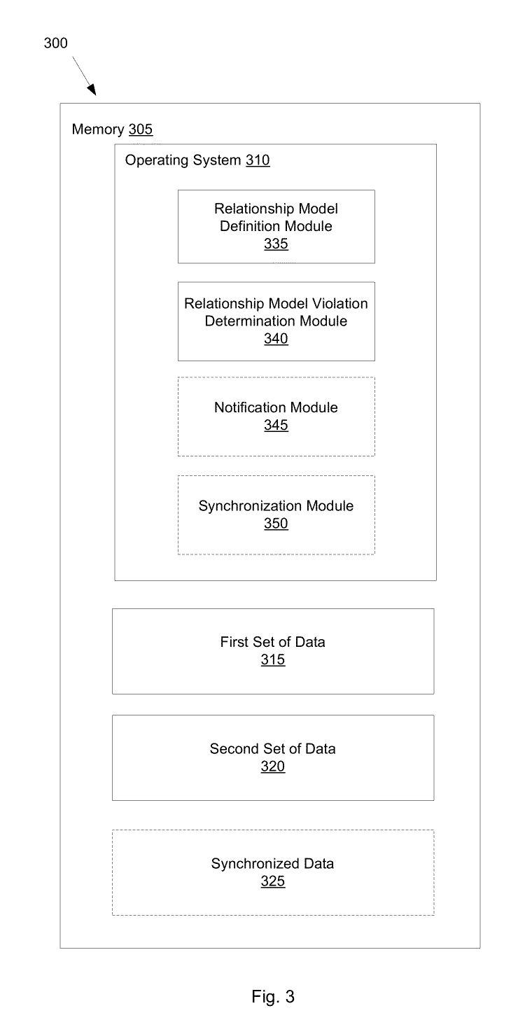

FIG. 3 illustrates an exemplary main memory 220 of FIG. 2 in accordance with one embodiment of the present invention. Referring to FIG. 3, memory 305 contains operating system 310, first set of data 315, second set of data 320, and synchronized data 325. Within operating system 310, there is relationship model definition module 335, relationship model violation determination module 340, notification module 345, and synchronization module 350. In other embodiments, the software components 335, 340, 345, and 350 can be separate from and not part of an operating system. Although memory 305 has been shown as a single memory, this is just one illustrative embodiment. In alternate embodiments, memory 305 can be split into more than one memory.

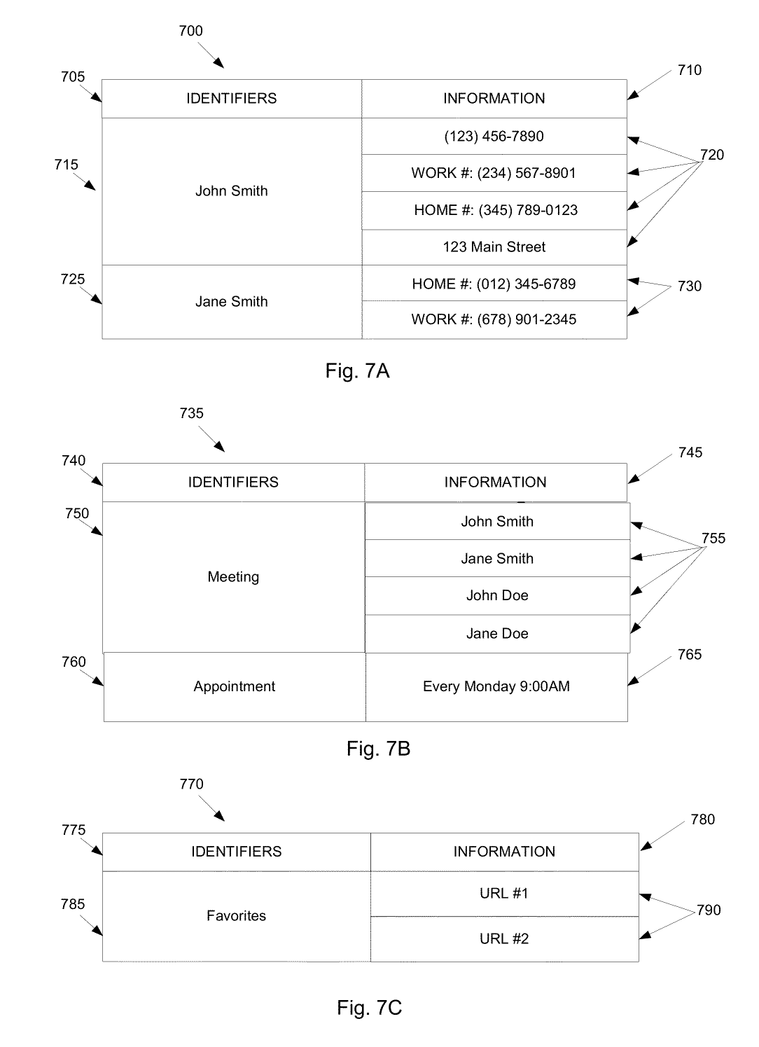

In one embodiment, data stored in memory 305 (e.g., first set of data 315, second set of data 320, and/or synchronized data 325) may include different types of personal data, such as contact data, calendar data, bookmark data, and/or any other type of data that can be synced. In one embodiment, data stored in memory 305 (e.g., first set of data 315, second set of data 320, and/or synchronized data 325) may include a plurality of entries, each entry being of a particular type (e.g., entries for contacts, entries for calendar(s), entries for bookmarks, etc.). In one embodiment, each entry in first set of data 315, second set of data 320, and/or synchronized data 325 can include an identifier and one or more sub-entries corresponding to that identifier. For example, a contact entry may include a name as the identifier (e.g., first, last, and/or middle name) and one or more phone entries for the name. In one embodiment, first set of data 315 can include entries as described below in conjunction with FIGS. 7A, 7B, and 7C.

Relationship model definition module 335 can define a relationship model for each type of data in first set of data 315. In one embodiment, relationship model definition module 335 can define a relationship model for a type of data based on the contents of data in first set of data 315 that are associated with the type of data. A relationship model may be a limitation on the contents of data to be synchronized with first set of data 315 (e.g., second set of data 320). In one embodiment, the relationship model may include an identifier for the data type and a corresponding relationship model value representing the limitation for the identified data type. In one embodiment, relationship model definition module 335 may determine one or more types of data in first set of data 315. In an alternate embodiment, relationship model definition module 335 receives one or more types of data in first set of data 315 along with a synchronization request. In another alternate embodiment, relationship model definition module 335 can obtain the one or more types of data from operating system 310.

In one embodiment, relationship model definition module 335 may update the relationship model for a data type corresponding to an entry in second set of data 320 that triggers a violation. In an alternate embodiment, relationship model definition module 335 redefines relationship models for each type of data in synchronized data 325

Relationship model violation determination module 340 can determine if an entry in second set of data 320 violates a relationship model for a type of data corresponding to the entry. In one embodiment, if an entry in second set of data 320 violates a relationship model for a type of data corresponding to the entry, relationship model violation determination module 340 may send a notification request to notification module 345. By determining if each entry in the second set of data 320 violates the relationship model for the data type corresponding to the entry, the duplication and propagation of duplicated data can be determined.

In one embodiment, notification module 345 may notify a user of a violation upon receiving a notification request from relationship model violation determination muddle 340. In one embodiment, notification module 345 can notify the user of the violation using a graphical user interface (GUI).

In one embodiment, once relationship model violation determination module 340 has made a violation determination for each entry in second set of data 320, synchronization module 350 determines whether to synchronize first set of data 315 and second set of data 320. In one embodiment, synchronization module 350 may automatically synchronize first set of data 315 and second set of data 320 if none of the entries in second set of data 320 violated the relationship model for the data type of the entries in second set of data 320. In an alternate embodiment, synchronization module 350 may synchronize first set of data 315 and second set of data 320 based on input from a user indicating that the user wishes to proceed with the synchronization. If synchronization module 350 synchronizes first set of data 315 and second set of data 320, the resulting synchronized data may be stored in synchronized data 325.

In certain embodiments, notification module 345, synchronization module 350, and synchronized data 325 can be optional. In certain embodiments, if notification module 345 is omitted, a user is not notified of a violation of a relationship model. In certain embodiments, if synchronization module 350 is omitted, first set of data 315 and second set of data 320 are not synchronized, and the synchronized data 325 is not written to memory 305.

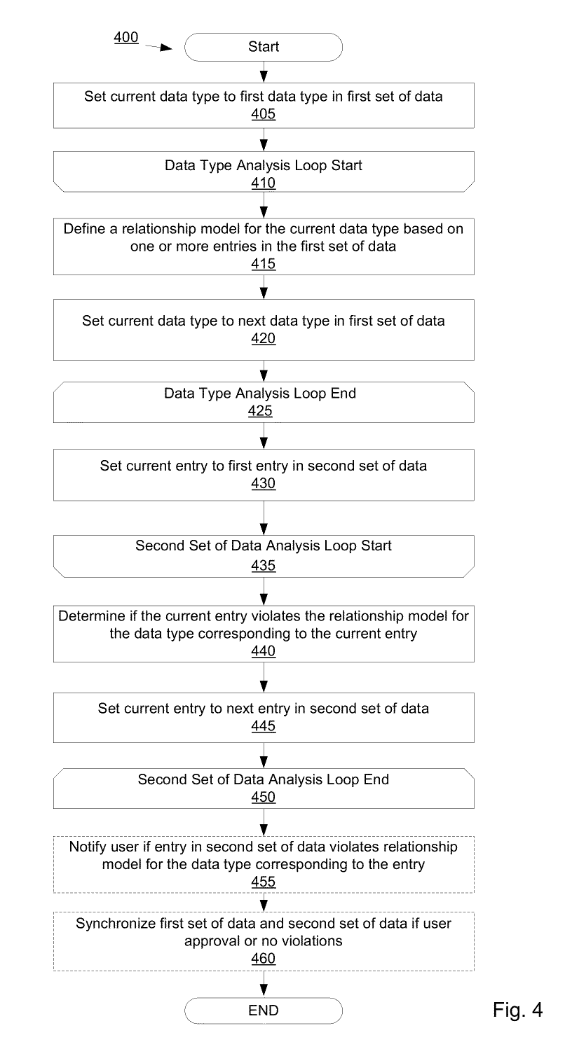

FIG. 4 illustrates a flow diagram of a method of semantic checking for synchronization of a first set of data and a second set of data in accordance with embodiments of the present invention. Semantic checking for synchronization method 400 may be performed by processing logic that comprises hardware (e.g., circuitry, dedicated logic, programmable logic, microcode, etc.), software (e.g., instructions run on a processing device to perform hardware simulation), or a combination thereof. In one embodiment, semantic checking for synchronization method 400 is performed by relationship model definition module 335, relationship model violation determination module 340, and notification module 345 of FIG. 3.

Referring to FIG. 4, method 400 starts at block 405. At block 405, the process can set a current data type to a first data type in a first set of data. In one embodiment, a first set of data may be stored on a first computer system to be synchronized with a second computer system or a mobile device storing a second set of data. In one embodiment, the sets of data may include personal data made up of one or more entries. In one embodiment, each entry can correspond to a type of data. For example, each entry is a contact entry, a calendar entry, a bookmark, etc. In one embodiment, each entry in the first set of data can include an identifier (e.g., name) and one or more sub-entries corresponding to the identifier. In some embodiments, prior to setting the current data type to the first data type if the first set of data, the process may first determine the data types corresponding to the entries in the first set of data. In one embodiment, the process may determine the data types by extracting the data types from metadata describing the first set of data.

The method 400 executes a loop to analyze the data types corresponding to the data in the first set of data beginning at block 410, ending at block 425, and performing the processes represented by blocks 415 through 420.

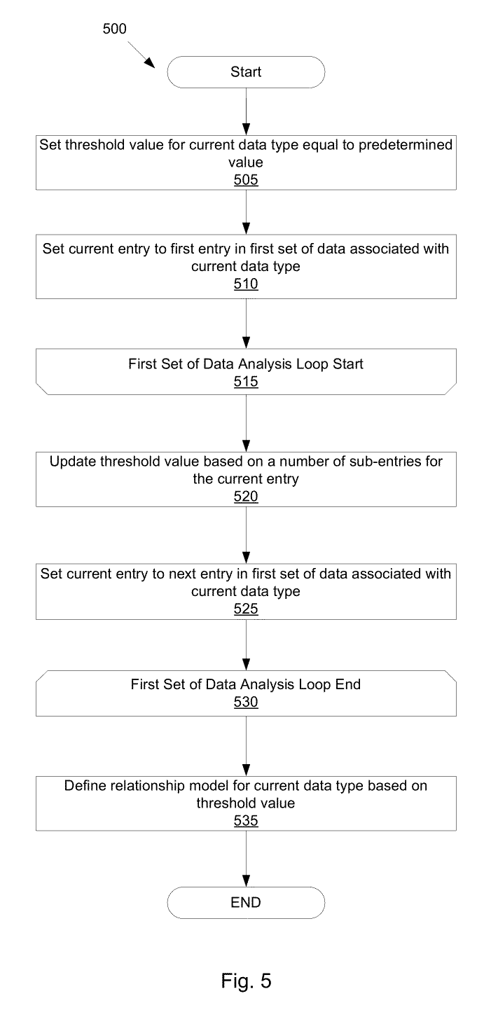

At block 415, the process can define a relationship model for the current data type based on one or more entries in the first set of data. In one embodiment, the relationship may be defined when a new device is added to a distributed system. In one embodiment, the relationship model may be defined based on only the entries in the first set of data that correspond to the current data type. In an alternate embodiment, the relationship model may be defined on all the entries in the first set of data. In another alternate embodiment, the relationship model may be predefined by an administrator. In one embodiment, the relationship model is defined as described below in conjunction with FIG. 5.

At block 420, the process can set the current data type to the next data type in the first set of data. If there are no additional data types in the first set of data, the loop ends and the method 400 proceeds to block 430.

At block 430, the process can set the current entry to the first entry in the second set of data.

The method 400 executes a loop to analyze a second set of data beginning at block 435, ending at block 450, and performing the processes represented by blocks 440 through 445.

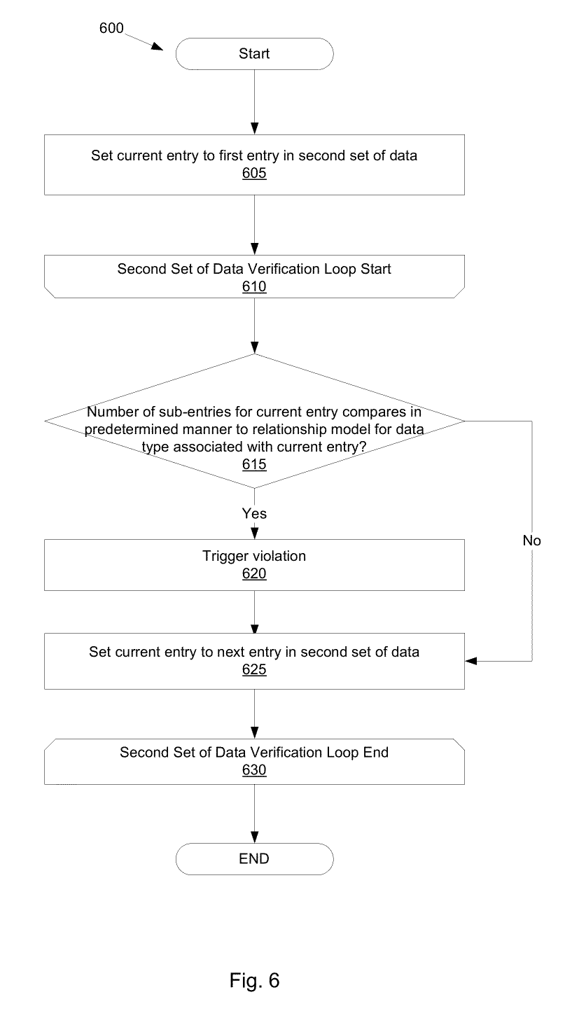

At block 440, the process can determine if the current entry violates the relationship model for the data type corresponding to the current entry. In one embodiment, whether the entry violates the relationship model may be determined as described below in conjunction with FIG. 6.

At block 445, the process can set the current entry to the next entry in the second set of data. If there are no additional entries in the second set of data, the loop ends and the method 400 proceeds to block 455.

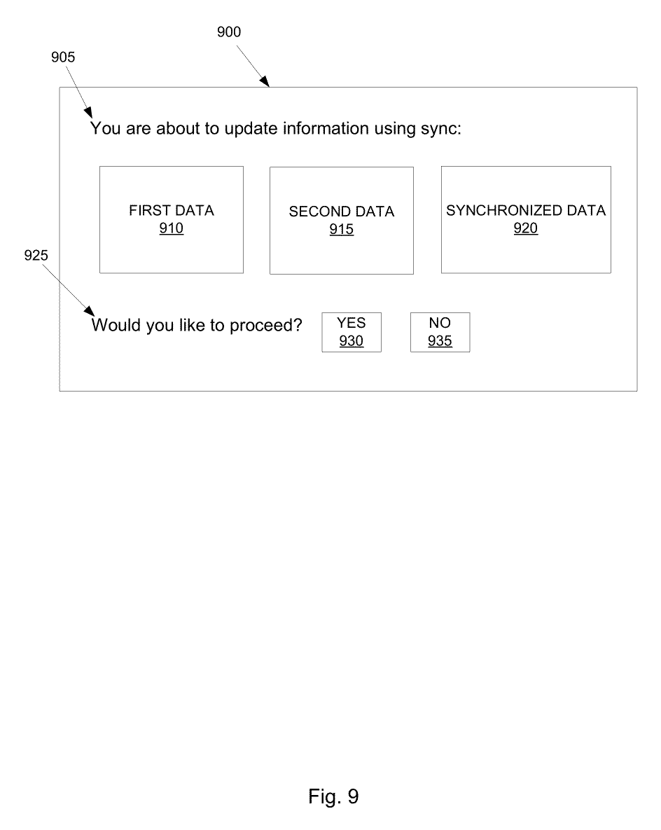

At block 455, the process may notify a user if any entry in the second set of data violates the relationship model for the data type corresponding to the entry. In one embodiment, the user may be notified using a GUI as described below in conjunction with FIG. 9.

At block 460, the process can synchronize the first set of data and the second set of data. In one embodiment, the first set of data and the second set of data may be synchronized only if the user approves of the synchronization. In an alternate embodiment, the first set of data and the second set of data may be synchronized if there are no violations of the relationship model(s) by the second set of data. In one embodiment, once the data has been synchronized, the process may end. In an alternate embodiment, once the data has been synchronized, the process can repeat the process represented by block 405 to 425 using the synchronized data. In this embodiment, the relationship model for each data type can be updated using the synchronized data to reflect any changes in the synchronized data within the relationship models.

In certain embodiments, blocks 455 and 460 are optional and are not performed. In one embodiment, block 455 and 460 are option if the data in the second set of data does not violate any of the relationship models defined based on the first set of data, or if the synchronization is set to fail automatically upon determining a violation exists. In certain embodiments, if blocks 455 and 460 are omitted, the process ends from block 450.

Method 400 illustrates one implementation of semantic checking for synchronization of a first set of data and a second set of data. In alternate embodiments, the order in which the blocks of method 400 are performed can be modified without departing from the scope of the invention.

FIG. 5 illustrates a flow diagram of a method of defining a relationship model in accordance with embodiments of the present invention. Relationship model definition method 500 may be performed by processing logic that comprises hardware (e.g., circuitry, dedicated logic, programmable logic, microcode, etc.), software (e.g., instructions run on a processing device to perform hardware simulation), or a combination thereof. In one embodiment, relationship model definition method 500 is performed by relationship model definition module 335 of FIG. 3.

Referring to FIG. 5, method 500 starts at block 505. At block 505, the process can set a threshold value for a current data type equal to a predetermined value (e.g., 0). For example, the current data type may be a contact, a calendar, a bookmark, etc. In one embodiment, the threshold value may be a maximum or minimum number of sub-entries associated with an entry for a current data type. In an alternate embodiment, the threshold value may be a mean value or average number of sub-entries associated with an entry for a current data type. In one embodiment, the type of threshold value may be selected by a user. In an alternate embodiment, the type of threshold value may be predetermined (e.g., average).

At block 510, the process can set a current entry to a first entry in a first set of data associated with the current data type.

The method 500 executes a loop to analyze the first set of data beginning at block 515, ending at processing instruction block 530, and performing the processes represented by blocks 520 and 525.

At block 520, the process can update the threshold value for a current data type based on a number of sub-entries for the current entry. In one embodiment, each entry in the first set of data may include an identifier and a number of sub-entries. In one embodiment, the threshold value may be updated by determining if the number of sub-entries for the current entry is greater than the current threshold value. If the number of sub-entries for the current entry is greater than the current threshold value, the threshold value may be updated to the number of sub-entries for the current entry. In this embodiment, the threshold value may be the maximum number of sub-entries associated with any entry in the first set of data for the current data type. For example, if the current threshold value is three and the current entry is a contact with five phone numbers (sub-entries), the threshold value for the contact data type may be updated to five. In an alternate embodiment, the threshold value may be updated to include the number of sub-entries for the current entry. In this embodiment, the threshold value may be a running total of the total number of sub-entries for entries in the first set of data that are associated with the current data type. In this embodiment, a count corresponding to the the number of entries for the first data set may be incremented when the threshold value is updated, in order to later compute an average number of sub-entries for the current data type.

At block 525, the process can set a current entry to a next entry in a first set of data associated with the current data type.

At block 535, the process can define a relationship model for the current data type based on the threshold value once all entries in the first set of data have been analyzed. In one embodiment, the relationship model may include a data type and a corresponding relationship model value for the data type. In one embodiment, if the threshold value is a maximum value (or minimum value) of sub-entries that can be associated with an entry, the relationship model may be defined by setting the relationship model value to be equivalent to the threshold value for the data type. In an alternate embodiment, if the threshold value is a maximum value (or minimum value) of sub-entries that can be associated with an entry, the relationship model value may be defined as the threshold value plus a predetermined value (e.g., 1) for the data type. In one embodiment, if the threshold value is a running total of the number of sub-entries in the first set of data associated with the current data type, the relationship model value may be defined by performing a calculation on the threshold value for the data type. In one embodiment, the calculation may be dividing the threshold value by the number of entries in the first set of data that are associated with the current data type to calculate the average number of sub-entries that may be associated with an entry. In an alternate embodiment, the relationship model value may be defined as a number of standard deviations (e.g., 3). In one embodiment, if relationship model value is not a whole number, the relationship model value may be rounded to the next whole number (e.g., 2.2 may be rounded to 3). In one embodiment, the relationship model value may be both a maximum value (or minimum value) of entries in the first set of data and a number of standard deviations.

Method 500 illustrates one implementation of defining a relationship model. In alternate embodiments, the order in which the blocks of method 500 are performed can be modified without departing from the scope of the invention.

FIG. 6 illustrates a flow diagram of a method of determining a relationship model violation in accordance with embodiments of the present invention. Relationship model violation determination method 400 may be performed by processing logic that comprises hardware (e.g., circuitry, dedicated logic, programmable logic, microcode, etc.), software (e.g., instructions run on a processing device to perform hardware simulation), or a combination thereof. In one embodiment, relationship model violation determination method 600 is performed by relationship model violation determination module 340 of FIG. 3.

Referring to FIG. 6, method 600 starts at block 605. At block 605, the process can set a current entry to a first entry in a second set of data.

The method 600 executes a loop to verify the second set of data beginning at block 610, ending at block 630, and performing the processes represented by blocks 615 through 625.

At block 615, the process can determine if a number of sub-entries for the current entry compares in a predetermined manner (e.g., greater than) to a relationship model value for the data type associated with the current entry. In one embodiment, if the relationship model contains multiple values, such as a maximum value and a number of standard deviations, a comparison of the number of sub-entries may be made for each of the multiple values. If the number of sub-entries for the current entry does not compare in a predetermined manner to the relationship model, the process may continue to block 625. If the number of sub-entries for the current entry compares in a predetermined manner to the relationship model, the process may continue to block 620.

At block 620, the process can trigger a violation. In one embodiment, triggering the violation may notify a user of the violation. In one embodiment, a GUI may be used to notify the user of the violation, such as the GUI as described below in conjunction with FIG. 9. For example, if the relationship model defines a maximum number of 10 people that can be invited to a meeting, and the current entry contains 100 sub-entries (such that 100 people are invited to a meeting), a violation would be triggered. Moreover, in this example, a user could be notified that there is a meeting with 100 people invited.

At block 625, the process can set a current entry to a next entry in the second set of data.

Method 600 illustrates one implementation of determining a relationship model violation. In alternate embodiments, the order in which the blocks of method 600 are performed can be modified without departing from the scope of the invention. For example, the violation may be triggered once all of the data in the second set of data has been verified.

FIG. 7A illustrates exemplary contact data 700 in accordance with one embodiment of the present invention. Contact data 700 may be obtained from a local memory, a local disk, from another system over a network, or from a remote server.

Referring to FIG. 7A, contact data 700 can contain identifiers 705 and information 710. Information 710 can include one or more sub-entries for the associated identifier 705. Identifier “John Smith” 715 can contain four sub-entries 720. Sub-entries 720 can include an uncategorized phone number, a work phone number, a home phone number, and an address. Identifier “Jane Smith” 725 can contain two sub-entries 730: a home phone number and a work phone number. The number of sub-entries in contact information 710 that are associated with identifiers 705 can be used in determining a threshold value for a set of contact data 700.

FIG. 7B illustrates exemplary calendar data 735 in accordance with one embodiment of the present invention. Calendar data 735 may be obtained from a local memory, a local disk, from another system over a network, or from a remote server.

Referring to FIG. 7B, calendar data 735 can contain identifiers 740 and information 745. Information 745 can include one or more sub-entries for the associated identifier 740. Identifier “Meeting” 750 can contain four sub-entries 755. Sub-entries 755 include different contacts invited to Meeting 750. Identifier “Appointment” 760 can contain a single sub-entry 765: an alarm for every Monday at 9:00 AM. The number of sub-entries in information 745 that are associated with identifiers 740 can be used in determining a threshold value for a set of calendar data 735.

FIG. 7C illustrates exemplary bookmark data 770 in accordance with one embodiment of the present invention. Bookmark data 770 may be obtained from a local memory, a local disk, from another system over a network, or from a remote server.

Referring to FIG. 7C, bookmark data 770 can contain identifiers 775 and information 780. Information 780 can include one or more sub-entries for the associated identifier 775. Identifier “Favorites” 785 can contain two sub-entries 790: URL #1 and URL #2. The number of sub-entries in information 780 that are associated with identifiers 775 can be used in determining a threshold value for a set of bookmark data 770.

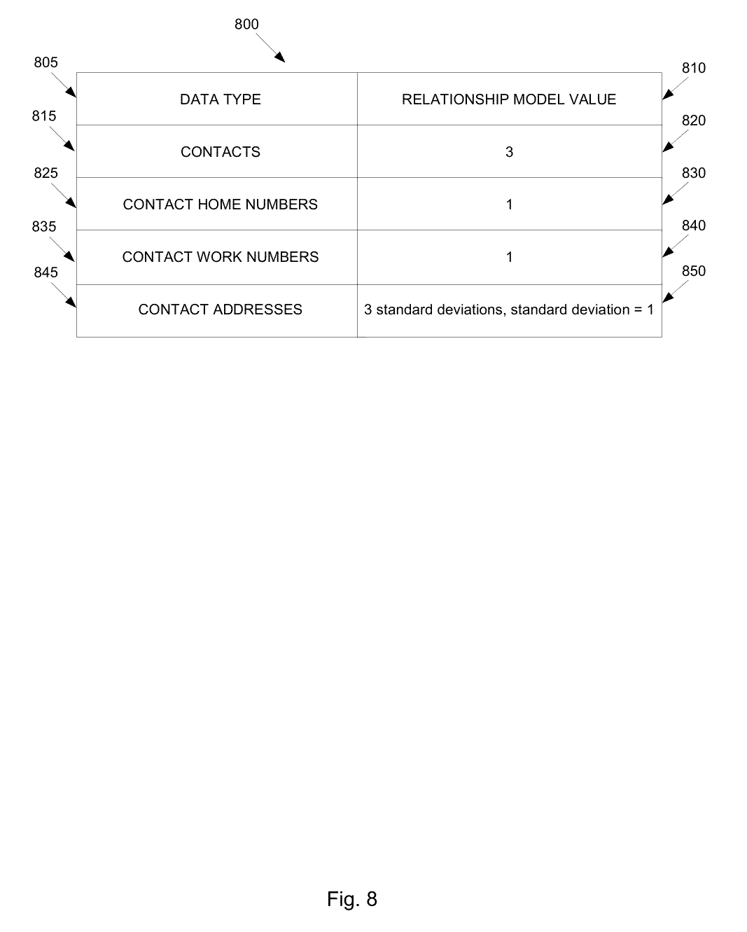

FIG. 8 illustrates an exemplary relationship model 800 in accordance with one embodiment of the present invention. Relationship model 800 may be defined as described above in conjunction with FIG. 5.

Referring to FIG. 8, relationship model 800 can contain data types 805 and a corresponding relationship model value 810 for each data type 805. Data type 805 can include contact data, calendar data, bookmark data, etc. Relationship model value 810 may be based on the number of sub-entries in data associated with the corresponding data type 805. In one embodiment, relationship model values 810 may be set to a maximum value (or minimum value) of sub-entries that can be associated with the corresponding data type 805. In an alternate embodiment, relationship model values 810 may be set to a calculated value plus a predetermined value. In another alternate embodiment, relationship model values 810 may be the average number of sub-entries that may be associated with the corresponding data type 805. In yet another alternate embodiment, relationship model values 810 may be set to a number of standard deviations from an average number of sub-entries. The relationship model values 810 may be set to different types for different data types 805.

For data type “contacts” 815, the relationship model value is “3” 820. Relationship model value 820 may be based on contact data such as the contact data in FIG. 7A. For example, based on contact data 700 and a relationship model value set to an average value of sub-entries, the corresponding relationship model value 820 for contacts 815 could be set to “3”, the average of the four sub-entries for identifier “John Smith” 715 and the two sub-entries for identifier “Jane Smith” 725.

Data types 805 can further be refined, such as contact home phone numbers 825 and contact work phone numbers 835. For these refined data types, relationship model values 830 and 840 are based on the specific sub-entries in contact data that correspond to these refined data types 825 and 835. For example, based on contact data 700 and a relationship model value set to a maximum value of sub-entries, the corresponding relationship model values 830 and 840 could be set to “1”, the maximum number of sub-entries for identifier “John Smith” 715 and identifier “Jane Smith” 725 corresponding to contact home phone numbers and contact work phone numbers.

For data type “contact address” 845, the relationship model value is “3 standard deviations, standard deviation=1.” This means that the maximum number of contact address sub-entries for an entry of data type “contact address” is 3. In one example, if a second set of data includes 4 contact addresses (such as 2 contact addresses that are duplicated during synchronization), the relationship model value would be violated.

FIG. 9 illustrates an exemplary GUI notification 900 in accordance with one embodiment of the present invention.

Referring to FIG. 9, GUI notification 900 can contain a general message 905 informing the user that certain information is about to be updated. In one embodiment, GUI notification 900 can further include first data 910, second data 915, and synchronized data 920. In one embodiment, first data 910 can be a specific entry in a first set of data on which a relationship model was based. In one embodiment, second data 915 can be an updated version of first data 910 in a second set of data that triggered a violation of the relationship model. In one embodiment, synchronized data 920 can show the resulting data from the synchronization of first data 910 and second data 915.

GUI notification 900 can further contain a message 925 asking the user if the user would like to continue based on first data 910, second data 915, and synchronized data 920. GUI notification 900 may further include a yes button 930 and a no button 935 to record an answer of the user. In one embodiment, the answer of the user may be used to determine whether to update a relationship model based on synchronized data 920.

The methods as described herein are not described with reference to any particular programming language. It will be appreciated that a variety of programming languages may be used to implement the teachings of the present invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result. It will be further appreciated that more or fewer processes may be incorporated into the methods 400, 500, and 600 in FIG. 4, FIG. 5, and FIG. 6 respectively, without departing from the scope of the invention and that no particular order is implied by the arrangement of blocks shown and described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A computer-implemented method for verifying synchronization comprising:
for each data type in a first set of data, defining, by the computer system, a relationship model for the data type based on one or more entries in the first set of data, wherein each entry in the first set of data is associated with the data type; and
for each entry in a second set of data, determining if the entry in the second set of data violates the relationship model for the data type corresponding to the entry, wherein the second set of data is to be synchronized with the first set of data.

2. The computer-implemented method of claim 1, further comprising:
notifying a user if the entry in the second set of data violates the relationship model for the data type corresponding to the entry.

3. The computer-implemented method of claim 2, wherein requesting input from the user comprises prompting the user through a graphical user interface (GUI).

4. The computer-implemented method of claim 1, further comprising:
analyzing, by a computer system, the first set of data to determine the one or more data types associated with the first set of data.

5. The computer-implemented method of claim 1, further comprising:
analyzing, by the computer system, the second set of data to determine the one or more data types associated with the second set of data.

6. The computer-implemented method of claim 1, wherein the relationship model is a statistical model using an average for the entries in the first set of data.

7. The computer-implemented method of claim 1, wherein the first set of data is at least one of contact data, calendar data, and bookmark data.

8. The computer-implemented method of claim 1, wherein determining if the entry in the second set of data violates the relationship model for the data type corresponding to the entry comprises comparing the entry in the second set of data with an average associated with the data type.

9. The computer-implemented method of claim 1, further comprising:
updating the relationship model for a data type based on the second set of data.

10. The computer-implemented method of claim 1, wherein the second set of data is data that has been duplicated by a synchronization process.

11. A computer-implemented method for verifying synchronization comprising:
defining, by the computer system, a first average for a data type, the data type being associated with a first subset, the first subset comprising one or more entries in a first set of data, the first average based on a number of sub-entries associated with the first subset; and
synchronizing the first set of data with a second set of data if a second average for the data type compares in a predetermined manner to the first average for the data type, the second set of data comprising a second subset, the second subset comprising one or more entries in the second set of data associated with the data type, the second average based on a number of sub-entries associated with the second subset.

12. The computer-implemented method of claim 11, wherein the data type is at least one of a contact, a calendar, and a bookmark.

13. The computer-implemented method of claim 11, further comprising:
for each entry in the first set of data,
determining if the entry in the first set of data is associated with the data type;
adding the entry in the first set of data to the first subset if the entry in the first set of data is associated with the data type; and
for each entry in the second set of data,
determining if the entry in the second set of data is associated with the data type;
adding the entry in the second set of data to the second subset if the entry in the second set of data is associated with the data type.

14. The computer-implemented method of claim 11, further comprising:
notifying a user if the second average for the data type does not compare in a predetermined manner to the first average for the data type.

15. The computer-implemented method of claim 11, further comprising:
updating the first average for the data type based on the second set of data.

16. A computer-readable storage medium comprising executable instructions to cause a processor to perform operations for recovery of a system, the instructions comprising:
for each data type in a first set of data, defining a relationship model for the data type based on one or more entries in the first set of data, wherein each entry in the first set of data is associated with the data type; and
for each entry in a second set of data, determining if the entry in the second set of data violates the relationship model for the data type corresponding to the entry, wherein the second set of data is to be synchronized with the first set of data.

17. The computer-readable storage medium of claim 16, wherein the instructions further comprise:
notifying a user if the entry in the second set of data violates the relationship model for the data type corresponding to the entry.

18. The computer-readable storage medium of claim 16, wherein the instructions further comprise:
analyzing the first set of data to determine the one or more data types associated with the first set of data; and
analyzing the second set of data to determine the one or more data types associated with the second set of data.

19. A computer-readable storage medium comprising executable instructions to cause a processor to perform operations for recovery of a system, the instructions comprising:
defining a first average for a data type, the data type being associated with a first subset, the first subset comprising one or more entries in a first set of data, the first average based on a number of sub-entries associated with the first subset; and
synchronizing the first set of data with a second set of data if a second average for the data type compares in a predetermined manner to the first average for the data type, the second set of data comprising a second subset, the second subset comprising one or more entries in the second set of data associated with the data type, the second average based on a number of sub-entries associated with the second subset.

20. The computer-readable storage medium of claim 19, wherein the instructions further comprise:
for each entry in the first set of data,
determining if the entry in the first set of data is associated with the data type;
adding the entry in the first set of data to the first subset if the entry in the first set of data is associated with the data type; and
for each entry in the second set of data,
determining if the entry in the second set of data is associated with the data type;
adding the entry in the second set of data to the second subset if the entry in the second set of data is associated with the data type.

21. The computer-readable storage medium of claim 19, wherein the instructions further comprise:
notifying a user if the second average for the data type does not compare in a predetermined manner to the first average for the data type.

22. The computer-readable storage medium of claim 19, wherein the instructions further comprise:
updating the first average for the data type based on the second set of data.

23. An apparatus comprising:
for each data type in a first set of data, means for defining a relationship model for the data type based on one or more entries in the first set of data, wherein each entry in the first set of data is associated with the data type; and
for each entry in a second set of data, means for determining if the entry in the second set of data violates the relationship model for the data type corresponding to the entry, wherein the second set of data is to be synchronized with the first set of data.

24. The apparatus of claim 23, further comprising:
means for notifying a user if the entry in the second set of data violates the relationship model for the data type corresponding to the entry.

25. The apparatus of claim 23, further comprising:
means for analyzing the first set of data to determine the one or more data types associated with the first set of data; and
means for analyzing the second set of data to determine the one or more data types associated with the second set of data.

26. An apparatus comprising:
means for defining a first average for a data type, the data type being associated with a first subset, the first subset comprising one or more entries in a first set of data, the first average based on a number of sub-entries associated with the first subset; and
means for synchronizing the first set of data with a second set of data if a second average for the data type compares in a predetermined manner to the first average for the data type, the second set of data comprising a second subset, the second subset comprising one or more entries in the second set of data associated with the data type, the second average based on a number of sub-entries associated with the second subset.

27. The apparatus of claim 26, further comprising:
for each entry in the first set of data,
means for determining if the entry in the first set of data is associated with the data type;
means for adding the entry in the first set of data to the first subset if the entry in the first set of data is associated with the data type; and
for each entry in the second set of data,
means for determining if the entry in the second set of data is associated with the data type;
means for adding the entry in the second set of data to the second subset if the entry in the second set of data is associated with the data type.

28. The apparatus of claim 26, further comprising:
means for notifying a user if the second average for the data type does not compare in a predetermined manner to the first average for the data type.

29. A computer system comprising:
a memory; and
a processor configurable by instructions stored in the memory to:
for each data type in a first set of data, define a relationship model for the data type based on one or more entries in the first set of data, wherein each entry in the first set of data is associated with the data type; and
for each entry in a second set of data, determine if the entry in the second set of data violates the relationship model for the data type corresponding to the entry, wherein the second set of data is to be synchronized with the first set of data.

30. A computer system comprising:
a memory; and
a processor configurable by instructions stored in the memory to:
define a first average for a data type, the data type being associated with a first subset, the first subset comprising one or more entries in a first set of data, the first average based on a number of sub-entries associated with the first subset; and
synchronize the first set of data with a second set of data if a second average for the data type compares in a predetermined manner to the first average for the data type, the second set of data comprising a second subset, the second subset comprising one or more entries in the second set of data associated with the data type, the second average based on a number of sub-entries associated with the second subset.
